(19) United States
(12) Patent Application Publication
(10) Pub. No.: US 2006/0286021 A1
(43) Pub. Date: Dec. 21, 2006

(54) High purity metaphosphate and method for production thereof

(75) Inventors: Kosuke Takeuchi, Aichi (JP); Toru Hata, Aichi (JP); Shunsuke Konishi, Aichi (JP); Kazuhiro Takahashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON CHEMICAL INDUSTRIAL CO., LTD., TOKYO (JP)

(21) Appl. No.: 10/548,528

(22) PCT Filed: Mar. 9, 2004
(86) PCT No.: PCT/JP04/03007

§ 371 Date: Sep. 12, 2005

(30) Foreign Application Priority Data
Mar. 14, 2003 (JP) 2003-070120

(51) Int. Cl. C01B 25/26

(52) U.S. Cl. 423/314

(57) ABSTRACT

A high purity metaphosphate is characterized in that the concentration of each coloring metal element serving as an impurity is 5 ppm or less. The metaphosphate is an aluminum salt, a barium salt, a calcium salt, a magnesium salt, or a strontium salt. The aluminum salt is suitably produced by means of a production method comprising a first step of producing a reaction mixture containing aluminum biphosphate by reacting an aluminum compound with phosphoric acid by heating, a second step of placing the reaction mixture containing aluminum biphosphate obtained in the first step in a firing vessel on which aluminum metaphosphate powder is spread in advance and subjecting the reaction mixture to firing, and a third step of pulverizing the fired product obtained in the second step.

### TECHNICAL FIELD

The present invention relates to a high purity metaphosphate and to a method for producing the same.

### BACKGROUND ART

Currently, environmental problems are becoming serious in the field of electronic materials. Under this circumstance, there is a demand for lead free. In the glass industry, lead-free has also been promoted. The development of a high refractive lens and a low melting point glass as alternatives to a lead glass has been in progress. In such a high refractive lens, the inclusion of coloring metals, particularly iron, is undesirable. A phosphate glass, a bismuth glass, a borosilicate glass, and the like have received attention as a promising material for a raw material of a high refractive lens. Particularly, for a raw material for the phosphate glass, a metaphosphate is considered to be effective due to a high phosphorus content per unit weight.

Representative examples of the metaphosphate employed as a raw material for the phosphate glass include aluminum metaphosphate and barium metaphosphate. Of these examples of the metaphosphate, it has been known that aluminum metaphosphate can be obtained by heating a mixed slurry of aluminum hydroxide and dibasic ammonium phosphate at 630° C. for one hour (see, for example, Japanese Patent Laid-Open Publication No. Sho 57-118007). Upon producing aluminum metaphosphate from raw materials including a phosphate, an aluminum salt, and an aluminum phosphate compound, it has been recently proposed that aluminum metaphosphate is produced by mixing aluminum metaphosphate powder with the raw materials and allowing to react during firing (see, for example, Japanese Patent Laid-Open Publication No. 2003-63811). In addition, it has also been known that aluminum metaphosphate is produced by the following method; aluminum hydroxide is reacted with phosphoric acid to form a reaction mixture containing aluminum biphosphate; and the reaction mixture is heated to a temperature of 700 to 750° C. by use of a spray dryer (see, for example, Khicmicheskaya Promyshlennost (Moscow, Russian Federation) 1982, 10, 595-7).

Besides aluminum metaphosphate, zinc metaphosphate is one of the metaphosphates and has been employed as an antimicrobial agent in addition to a raw material for a phosphate glass. It has been known that zinc metaphosphate is obtained by, for example, heating zinc oxide and phosphoric acid at 600° C. for four hours (see, for example, Japanese Patent Laid-Open Publication No. Hei 8-165213).

### DISCLOSURE OF THE INVENTION

However, in the production method disclosed in Japanese Patent Laid-Open Publication No. Sho 57-118007, ammonia is produced during firing, and thus equipment for waste gas treatment or the like must be provided. In addition, the content of impurities cannot be reduced.

Japanese Patent Laid-Open Publication No. 2003-63811 suggests that high purity aluminum metaphosphate can be obtained. However, a preferred reaction employed for preventing caking utilizes a solid phase reaction in which water content is reduced as much as possible. Thus, the following drawbacks are encountered: the reaction is not fully completed; and the molar ratio (P₂O₅/Al₂O₃) is hard to control. Further, the content of impurities is not specifically described.

In the method disclosed in Khicmicheskaya Promyshlennost (Moscow, Russian Federation, 1982, 10, 595-7), use of a spray dryer unavoidably results in contamination caused by a spray nozzle or the like.

In Japanese Patent Laid-Open Publication No. Hei 8-165213, the production method of zinc metaphosphate is only briefly described, and the details of the production method and the content of impurities are not described.

Accordingly, it is an object of the present invention to provide a high purity metaphosphate and a method for producing the same which can overcome the above-described drawbacks in the conventional technology.

The above object is achieved according to the present invention by providing a high purity metaphosphate characterized in that the concentration of each coloring metal element serving as an impurity is 5 ppm or less.

The present invention also provides a method for producing a high purity metaphosphate, as a preferred method for producing the abovementioned metaphosphate, comprising the steps of:

producing a phosphate of a metal by reacting phosphoric acid with a compound of the metal which composes a metaphosphate; and

placing the phosphate obtained in the previous step on a powder of a metaphosphate which is spread in a firing vessel prior to placing the phosphate, followed by subjecting the phosphate to firing.

Further, the present invention provides a method for producing a high purity metaphosphate, as a preferred production method when the abovementioned metaphosphate is an aluminum salt, characterized in that

placing a mixture obtained by mixing an aluminum compound, anhydrous phosphoric acid, and ployphosphoric acid on aluminum metaphosphate powder which is spread in a firing vessel prior to placing the mixture and, subjecting the mixture to firing.

### BRIEF DESCRIPTION OF THE DRAWINGS

FIG. 1 is an XRD chart of the aluminum metaphosphate obtained in Example.

FIG. 2 is an XRD chart of the barium metaphosphate obtained in Example.

FIG. 3 is an XRD chart of the zinc metaphosphate obtained in Example.

FIG. 4 is an XRD chart of the calcium metaphosphate obtained in Example.

FIG. 5 is an XRD chart of the magnesium metaphosphate obtained in Example.

### BEST MODE FOR CARRYING OUT THE INVENTION

The present invention will next be described by way of preferred embodiments thereof. In the description hereinafter, “%” and “ppm” are based on weight unless otherwise specified. The metaphosphate of the present invention contains coloring metal elements as impurities each in a concentration of 5 ppm or less, preferably 3 ppm or less. The metaphosphate of the present invention contains at least one coloring metal element from among iron, chromium, nickel, manganese, and copper. If a metaphosphate containing a coloring metal element in a concentration of more than 5 ppm is employed as, for example, a raw material for producing an optical lens, the degree of coloring of the obtained optical lens becomes significantly high. Iron causes to increase the degree of coloring more than the other coloring metal elements do, if the degrees of coloring are compared at the same concentration. Thus, reducing the iron concentration is effective. Particularly, in view of this, the iron concentration is preferably 5 ppm or less, more preferably 3 ppm or less.

The content of each of the coloring metal elements in the metaphosphate of the present invention is determined by ICP emission spectroscopy by use of a measurement sample which is prepared by dissolving the metaphosphate in an aqueous solution of sodium hydroxide by heating.

Examples of the metaphosphate of the present invention include an aluminum salt, a barium salt, a zinc salt, a calcium salt, a magnesium salt, and a strontium salt. The salt to be employed is appropriately determined in accordance with the specific application of the metaphosphate. The identification of these metaphosphates can be carried out by means of XRD.

The metaphosphate of the present invention contains free phosphoric acid (P₂O₅) in an amount of preferably 2% or less, more preferably 11% or less, most preferably 0.3% or less. If the amount of free phosphoric acid exceeds 2%, the hygroscopicity increases to cause the moisture amount in the metaphosphate to increase. Thus, when the metaphosphate of the present invention is employed as a raw material for producing an optical lens, problems such as bad handling and a change in the refractive index of a glass occasionally arise. The abovementioned free phosphoric acid is the phosphoric acid which elutes during washing with water, and the content thereof is calculated on the basis of P₂O₅.

The metaphosphate of the present invention has a purity of preferably 96% or higher, more preferably 97% or higher. If the purity is lower than 96%, and when the metaphosphate of the present invention is employed as a raw material for producing an optical lens, problems such as bad handling and a change in the refractive index of a glass occasionally arise, as described in the case of free phosphoric acid. The abovementioned purity is not the purity of a metaphosphate. The content (wt. %) of P₂O₅ and the content (wt. %) of an oxide of the metal forming the metaphosphate (hereinafter simply referred to as a metal oxide) are determined separately, and the sum thereof serves as the purity.

In the case of aluminum metaphosphate, the molar ratio of P₂O₅ to metal oxide (P₂O₅/metal oxide) in the metaphosphate is preferably P₂O₅/Al₂O₃=2.4 to 3.2, more preferably 2.7 to 3.1, most preferably 3 to 3.05. In the case of barium metaphosphate, the molar ratio is preferably P₂O₅/BaO=0.85 to 1.1, particularly preferably 0.9 to 1. If the molar ratio falls within the above ranges, an increase in free phosphoric acid can easily be prevented.

The content of P₂O₅ in the metaphosphate can be determined by means of a colorimetric method through mixing with ammonium vanadate and ammonium molybdate. On the other hand, the content of a metal oxide (for example, Al₂O₃ or BaO) in the metaphosphate can be determined by means of ICP emission spectroscopy. The details of the above measurement methods will be described hereinafter in Examples.

The metaphosphate of the present invention has an ignition loss of preferably 2% or less, particularly preferably 1% or less. In this manner, when the metaphosphate of the present invention is employed as a raw material for producing an optical lens, the problems such as bad handling and a change in the refractive index of a glass can be effectively prevented as in the case of the free phosphoric acid and the purity.

Next, a preferred method for producing the metaphosphate of the present invention will be described. The present production method comprising steps of: producing a phosphate of a metal by reacting phosphoric acid with a compound of the metal which composes a metaphosphate; and placing the phosphate obtained in the previous step on a powder of a metaphosphate which is spread in a firing vessel prior to placing the phosphate, followed by subjecting the phosphate to firing. The abovementioned phosphate in the present production method is a biphosphate represented by M(H₂PO₄)ₙ (wherein M represents a metal, and n represents the valence of M). The present production method will be described by way of an example of the production method of aluminum metaphosphate which is one of the metaphosphates.

(1) First Step

In the first step, a compound of a metal forming a metaphosphate is reacted with phosphoric acid. The “compound of a metal forming a metaphosphate” shall refer to, for example, an aluminum compound when the metaphosphate is an aluminum salt. Examples of the aluminum compound suitably employed include aluminum hydroxide and aluminum oxides such as α-alumina, β-alumina, and γ-alumina. Particularly, aluminum hydroxide is preferably employed since a high purity product is readily available industrially. If an aluminum oxide is employed, preferably, a suitable amount of water is added in addition to the aluminum oxide and the phosphoric acid. This is because aluminum biphosphate is caked in the reaction system to cause a difficulty in removal as liquid. On the other hand, no particular limitation is imposed on the phosphoric acid, but high purity phosphoric acid having a purity of 85% or higher is preferable. The phosphoric acid for electronics materials is particularly preferable. Such a phosphoric acid is available from, for example, Nippon Chemical Industrial Co., Ltd. The above two materials can be mixed at room temperature.

When aluminum hydroxide or an aluminum oxide is employed as the aluminum compound, the reaction in this step is represented by the corresponding formula shown below. As is clear from the formula, a phosphate of aluminum (aluminum biphosphate) is obtained through the reaction.
Al(OH)₃+3H₃PO₄→Al(H₂PO₄)₃+3H₂0.
Al₂O₃+6H₃PO₄+3H₂O→2Al(H₂PO₄)₃+6H₂O.

The above-described reaction may be performed at room temperature or under heating. The reaction temperature may be up to 150° C. and is normally 100 to 120° C. No particular limitation is imposed on the reaction time, but the reaction time is normally about 30 minutes.

The molar ratio of phosphoric acid to an aluminum compound upon charging is preferably a stoichiometric ratio. However, the molar ratio represented by P₂O₅/aluminum compound may be arbitrarily adjusted within the range of 2.7 to 3.1.

The phosphate of aluminum obtained by the above-described reaction is a viscous liquid consisting essentially of aluminum biphosphate and containing about 25 wt. % of water.

(2) Second Step

In this step, under the state in which aluminum metaphosphate powder has been spread on a firing vessel, the viscous liquid produced as the reaction product of the first step is placed in the firing vessel. In this manner, the reaction product of the first step does not directly contact with the bottom of the firing vessel. This results in an advantage that the amount of impurities contained in the aluminum metaphosphate produced as the reaction product is reduced. This also results in an advantage that the aluminum metaphosphate is easily released from the reaction vessel. As described above, the aluminum metaphosphate powder spread on the firing vessel in advance serves as a setter powder. The releasability between the firing vessel and the fired product and the impurity concentration in the fired product are affected by the manner of spreading the aluminum metaphosphate powder. Therefore, preferably, the aluminum metaphosphate powder is uniformly spread on the bottom and, if possible, the wall of the firing vessel.

No particular limitation is imposed on the ratio of the aluminum metaphosphate powder spread on the firing vessel to the reaction product of the first step placed in the vessel, but the weight ratio, the former: the latter, is preferably 40:60 to 60:40 for preventing contact between the reaction product of the first step and the firing vessel.

In this step, no particular limitation is imposed on the firing vessel, so long as contamination with coloring metals is prevented in the vessel. Preferably, a vessel made of, for example, metal aluminum, alumina, cordierite, or enamel glass in which the surface of a metal is coated with ceramics is employed. Particularly preferably, a vessel made of metal aluminum or alumina is employed. In this manner, contamination with coloring metal elements can be prevented as much as possible.

The following reaction occurs during firing in this step:
Al(H₂PO₄)₃→Al(PO₃)₃+3H₂O.

The firing temperature is preferably 350° C. or higher, more preferably 500° C. or higher, particularly preferably 550° C. or higher. If the firing temperature is too low, the dehydration of the aluminum biphosphate produced as the reaction product of the first step is not completed, resulting in a tendency for free phosphate to increase. No particular limitation is imposed on the upper limit of the firing temperature, but the upper limit depends on the melting point or the like of the firing vessel. If the firing vessel is made of metal aluminum, the upper limit of the firing temperature is about 650° C. If the firing vessel is made of alumina, the upper limit of the firing temperature is the melting point or lower of aluminum metaphosphate.

No particular limitation is imposed on the firing time. Generally, a firing time of 2 hours or longer is sufficient, but the firing time is preferably 3 hours to 6 hours. Upon completion of the firing, the fired product is cooled to obtain a lump of aluminum metaphosphate produced as the fired product. No particular limitation is imposed on the above-described firing step, but a batch method through single-stage firing or multistage firing, or continuous firing in a continuous firing furnace such as a roller hearth kiln may be employed.

(3) Third Step

High purity aluminum metaphosphate containing a small amount of impurities can be obtained through the above steps. At this point, the aluminum metaphosphate has been obtained as a lump and thus, in some cases, exhibits poor handleability. Therefore, the third step of pulverizing the fired product obtained in the second step may be performed. In this step, the pulverization of the fired product is preferably performed by use of a pulverizer lined with alumina or the like in order to prevent impurity contamination. The degree of pulverization depends on the specific application of aluminum metaphosphate. For a raw material for producing an optical lens, a sieve of preferably about 16 to 32 mesh, particularly preferably about 20 to 28 mesh is employed.

(4) Fourth Step

If an excessive amount of phosphoric acid is contained in the aluminum metaphosphate powder obtained by the pulverization, moisture is absorbed on the surface. This may result in caking or the formation of aggregates during storage. Therefore, the fourth step of washing with water and then drying the powder obtained in the third step to remove free phosphate may be performed. The thus-obtained aluminum metaphosphate is employed for various applications. A part of the obtained aluminum metaphosphate is employed as the aluminum metaphosphate powder for spreading on the firing vessel in the second step.

Next, a preferred method for producing barium metaphosphate, which is another example of a metaphosphate, will be described. The same description as in the above-described production method for aluminum metaphosphate is appropriately applied if a specific description is not given for this production method. This production method comprises: a first step of producing a reaction product by reacting a barium compound with phosphoric acid by heating; and a second step of placing the reaction product obtained in the first step in a firing vessel on which barium metaphosphate powder is spread in advance and subjecting the reaction product to firing. The reaction product obtained in the first step is granular. The barium compound employed as a raw material remains unreacted around the center of the grain, and unreacted H₃PO₄ sticks on the surface of the grain. Thus, Ba(H₂PO₄)₂ is presumed to be formed between the unreacted portions.

(1) First Step

Examples of the barium compound suitably employed in the first step include barium hydroxide and barium carbonate. Particularly, barium carbonate is preferably employed since a high purity product is readily available industrially. On the other hand, no particular limitation is imposed on the phosphoric acid, but high purity phosphoric acid having a purity of 85% or more is preferable. The phosphoric acid for electronics materials is particularly preferable. The above two materials may be mixed at room temperature.

When barium carbonate or barium hydroxide is employed as the barium compound, the reaction in this step is represented by the corresponding formula shown below.
BaCO₃+2H₃PO₄→Ba(H₂PO₄)₂+3H₂O+CO₂
Ba(OH)₂+2H₃PO₄+3H₂O→Ba(H₂PO₄)₂+2H₂O

The above reactions may be performed at room temperature or under heating. The reaction temperature may be up to 100° C. and is normally 70 to 80° C. No particular limitation is imposed on the reaction time, but the reaction time is normally about 30 minutes.

The molar ratio of phosphoric acid to a barium compound upon charging is represented by P₂O₅/BaO and may be arbitrarily adjusted within the range of 0.85 to 1.1.

The reaction product obtained in the above reaction is a powder containing moisture.

(2) Second Step

In this step, under the state in which barium metaphosphate powder has been spread on a firing vessel, the reaction product obtained in the first step is placed in the firing vessel. In this manner, the reaction product obtained in the first step does not directly contact with the firing vessel. This results in an advantage that the amount of impurities contained in the barium metaphosphate produced as the reaction product of the second step is reduced. This also results in an advantage that barium metaphosphate is easily released from the reaction vessel. As described above, the barium metaphosphate powder spread on the firing vessel in advance serves as a setter powder. In view of this, preferably, the barium metaphosphate powder is uniformly spread on the bottom and, if possible, the wall of the firing vessel.

No particular limitation is imposed on the ratio of the barium metaphosphate powder spread on the firing vessel to the reaction product obtained in the first step, but the weight ratio, the former: the latter, is preferably 40:60 to 60:40 for preventing contact between the reaction product obtained in the first step and the firing vessel.

The same firing vessel as employed in the above-described production method for aluminum metaphosphate may be employed.

The following reaction occurs during the firing performed in this step:
Ba(H₂PO₄)₂→Ba(PO₃)₂+2H₂O

The firing temperature is preferably 350° C. or higher, more preferably 500° C. or higher, particularly preferably 550° C. or higher. If the firing temperature is too low, the dehydration of the reaction product obtained in the first step is not completed, resulting in a tendency for free phosphate to increase. No particular limitation is imposed on the upper limit of the firing temperature, but the upper limit depends on the melting point or the like of the firing vessel. If the firing vessel is made of metal aluminum, the upper limit of the firing temperature is about 650° C. If the firing vessel is made of alumina, the upper limit of the firing temperature is the melting point or lower of barium metaphosphate.

No particular limitation is imposed on the firing time. Generally, a firing time of 2 hours or longer is sufficient, but the firing time is preferably 3 hours to 6 hours. Upon completion of the firing, the fired product was cooled to obtain a lump of barium metaphosphate produced as the fired product.

After the second step, the third step and the fourth step described above may be performed in accordance with need.

Next, a method for producing zinc metaphosphate, which is another metaphosphate, will be described. The same description as in the above-described production method for aluminum metaphosphate or barium metaphosphate is appropriately applied if a specific description is not given for this production method. For example, zinc oxide may be employed as the zinc compound employed in the first step. The zinc oxide is mixed with phosphoric acid at room temperature, and the mixed solution is heated up to 200° C. to concentrate. The concentrated solution is transferred to a Teflon (a registered trademark) vessel, and cooled to room temperature. In this manner, zinc biphosphate consisting of a glassy solidified substance is obtained. The reaction in this step is represented by the following formula:
ZnO+2H₃PO₄→Zn(H₂PO₄)₂+H₂O

When the grain of the zinc oxide is coarse, the grain occasionally remains undissolved upon mixing with phosphoric acid. Therefore, the grains are sieved with a sieve having an aperture of 1 mm before the reaction, and, preferably, only the fine grains are employed.

The molar ratio of zinc oxide to phosphoric acid (the former: the latter) is preferably 1:2, but phosphoric acid may be about 1 to 2% excess. If zinc oxide is excess, the zinc metaphosphate to be obtained undesirably becomes gray.

The reaction takes place through mixing zinc oxide powder with phosphoric acid and heating from room temperature to 200° C. The water produced by the reaction is removed by heating. When the temperature reaches about 140° C. after starting heating, the zinc oxide almost fully dissolves to form a clear solution. Subsequently, about 80% or more of the water content in the solution evaporates at about 180° C. The upper limit of the heating temperature of this reaction is preferably 200° C., more preferably 180° C. The reaction time is preferably 10 minutes to 5 hours, more preferably 30 minutes to 40 minutes. Upon completion of the reaction, the reaction product is cooled to form a glassy solidified substance. This solidified substance comprises amorphous zinc biphosphate. No particular limitation is imposed on the cooling method. For example, the reaction product may only be allowed to stand at room temperature. If cooling is necessarily preformed at a faster rate, rapid cooling through immersing into cold water may be performed.

The zinc biphosphate obtained in the first step is subjected to firing in the second step to obtain zinc metaphosphate. The reaction in this step is represented by the following formula:
Zn(H₂PO₄)₂→Zn(PO₃)₂+2H₂O

The same firing temperature and firing time as in the case of the above-described aluminum metaphosphate and barium metaphosphate may be employed. After the second step, the above-described third step and fourth step may be performed in accordance with need.

The methods for producing different metaphosphates have, been described hereinabove. However, in a method for producing other metaphosphates, the same procedure as in the above-described methods may be followed, except that a different metal compound is employed in the first step and a different metaphosphate spread on the firing vessel is employed in the second step. For example, when calcium metaphosphate is produced, calcium carbonate, calcium hydroxide, calcium oxide, or the like may be employed as the calcium compound employed in the first step, and a calcium salt may be employed as the metaphosphate spread on the firing vessel in the second step. When magnesium metaphosphate is produced, magnesium carbonate, magnesium hydroxide, magnesium oxide, or the like may be employed as the magnesium compound employed in the first step, and a magnesium salt may be employed as the metaphosphate spread on the firing vessel in the second step. When strontium metaphosphate is produced, strontium hydroxide, strontium oxide, strontium carbonate, or the like may be employed as the strontium compound employed in the first step, and a strontium salt may be employed as the metaphosphate spread on the firing vessel in the second step.

In addition to the production methods described above, the method to be described hereinafter may be employed in the case of producing aluminum metaphosphate. The same description as in the above-described production methods is appropriately applied if a specific description is not given for this production method. In this production method, the mixture obtained through mixing an aluminum compound, anhydrous phosphoric acid, and ployphosphoric acid is placed on aluminum metaphosphate powder which is spread in a firing vessel prior to placing the mixture and, subjecting the mixture to firing.

The same aluminum compound as employed in the above-described production method for aluminum metaphosphate may be employed. No particular limitation is imposed on the kind of the anhydrous phosphoric acid (i.e., P₂O₅) and the polyphosphoric acid (for example, 116% H₃PO₄), so long as these materials are industrially available. For example, these materials are available from Nippon Chemical Industrial Co., Ltd.

In a general method for producing aluminum metaphosphate, an aluminum compound and anhydrous phosphoric acid are mixed and subjected to firing. However, in such a production method, the reaction does not proceed sufficiently. Thus, the obtained aluminum metaphosphate is not white, and the content of free phosphoric acid and the ignition loss become higher. Therefore, in this production method, polyphosphoric acid is added to and mixed with an aluminum compound and anhydrous phosphoric acid. In this manner, water is supplemented to the reaction system to promote a uniform firing reaction. The purpose of adding polyphosphoric acid is to improve the degree of mixing of the raw materials (an aluminum compound and anhydrous phosphoric acid).

When aluminum hydroxide is employed as the aluminum compound, the reaction in the present production method is represented by the following formula:
Al(OH)₃+P₂O₅+H₃PO₄→Al(H_{2 PO}₄)₃→Al(PO₃)₃+3H₂O

First, an aluminum compound is mixed with anhydrous phosphoric acid. The mixing may be performed at room temperature. The mixing time depends on the amount of the mixture, but a mixing time of 5 minutes or longer is sufficient. Subsequently, polyphosphoric acid is added to and mixed with the mixture of the above materials. A special procedure is unnecessary also at this point. A mixing time of 5 minutes or longer is sufficient. As is clear from the above reaction formula, in this reaction, it is conceivable that aluminum biphosphate is generated in the course of generating aluminum metaphosphate.

If the total content of anhydrous phosphoric acid and polyphosphoric acid is calculated on the basis of P₂O₅, the molar ratio of P₂O₅ to an aluminum compound is preferably P₂O₅/Al₂O₃=2.4 to 3.2, more preferably 2.7 to 3.1, most preferably 3 to 3.05.

The mixture obtained through mixing the three materials is a soft viscous rice-cake-like substance. The mixture is subjected to firing in a vessel on which aluminum metaphosphate powder is spread in advance. The reason for spreading the aluminum metaphosphate powder on the reaction vessel in advance is the same as in the above-described production methods. Further, the same firing conditions are employed.

The thus-obtained aluminum metaphosphate produced as the fired product is pulverized, washed with water, and then dried. The details of these steps are the same as in the above-described production method.

The thus-obtained various metaphosphates are particularly suitably employed as a raw material for producing an optical lens for a digital video, a digital camera, and the like, a raw material for producing a high transparency glass for short wavelength laser in a digital video disc player, a raw material for producing a fiber for amplification, and a raw material for a secondary battery electrolyte. Particularly, the metaphosphates are suitably employed as a raw material for an optical lens.

### EXAMPLES

The present invention will next be described in more detail by way of Examples. However, the scope of the present invention is not limited to the Examples.

### Example 1-1

(1) First Step

345.9 g of phosphoric acid (product of Nippon Chemical Industrial Co., Ltd., concentration of H₃PO₄:85%, pure phosphoric acid) was charged into a 2-liter beaker, and then 78.0 g of high purity aluminum hydroxide was added thereto. The molar ratio calculated on the basis of P₂O₅ and Al₂O₃ (P₂O₅/Al₂O₃) was 3.00. The beaker was heated by use of an electric heater to initiate the reaction. The temperature of the solution increased up to about 120° C. due to the heat of reaction. This state was, maintained for 30 minutes. The reaction mixture containing aluminum biphosphate was produced through the reaction.

(2) Second Step

The reaction mixture containing aluminum biphosphate obtained in the first step was transferred to a metal aluminum firing vessel on which aluminum metaphosphate powder was spread in advance. The firing vessel was placed in an electric furnace and heated to 550° C. This temperature was maintained for 4 hours for firing. Upon completion of the firing, the fired product was cooled to obtain a lump of aluminum metaphosphate.

(3) Third Step

The lump of aluminum metaphosphate obtained in the second step was pulverized in an alumina mortar to thereby obtain aluminum metaphosphate powder.

### Example 1-2

The same procedure as in Example 1-1 is followed, except that the aluminum metaphosphate powder obtained in the third step of Example 1-1 was washed with pure water and dried in a dryer.

### Example 1-3

345.9 g of phosphoric acid (product of Nippon Chemical Industrial Co., Ltd., concentration of H₃PO₄:85 wt. %, pure phosphoric acid) and 27 g of pure water were charged into a 2-liter beaker, and 51 g of α-alumina was added thereto. The molar ratio calculated on the basis of P₂O₅ and Al₂O₃ (P₂O₅/Al₂O₃) was 3.00:1. The beaker was heated by use of an electric heater to initiate the reaction. The temperature of the solution increased to about 130° C. due to the heat of reaction. This state was maintained for 30 minutes. The reaction mixture containing aluminum biphosphate was produced through the reaction. Subsequently, the same steps as in the second step and the third step of Example 1-1 were followed to thereby obtain aluminum metaphosphate.

### Example 1-4

349.3 g of phosphoric acid (product of Nippon Chemical Industrial Co., Ltd., concentration of H₃PO₄:85 wt. %, pure phosphoric acid) was charged into a 2-liter beaker, and 78.0 g of high purity aluminum hydroxide was added thereto. The molar ratio calculated on the basis of P₂O₅ and Al₂O₃ (P₂O₅/Al₂O₃) was 3.06:1. The beaker was heated by use of an electric heater to initiate the reaction. The temperature of the solution increased to about 120° C. due to the heat of reaction. This state was maintained for 30 minutes. The reaction mixture containing aluminum biphosphate was produced through the reaction. Subsequently, the same steps as in the second step and the third step of Example 1-1 were followed to thereby obtain aluminum metaphosphate.

### Example 1-5

308.2 g of phosphoric acid (product of Nippon Chemical Industrial Co., Ltd., concentration of H₃PO₄:85 wt. %, pure phosphoric acid) was charged into a 2-liter beaker, and 78.0 g of high purity aluminum hydroxide was added thereto. The molar ratio calculated on the basis of P₂O₅ and Al₂O₃ (P₂O₅/Al₂O₃) was 2.70:1. The beaker was heated by use of an electric heater to initiate the reaction. The temperature of the solution increased to about 120° C. due to the heat of reaction. This state was maintained for 30 minutes. The reaction mixture containing aluminum biphosphate was produced through the reaction. Subsequently, the same steps as in the second step and the third step of Example 1-1 were followed to thereby obtain aluminum metaphosphate.

### Example 1-6

The same procedure as in Example 1-1 was followed, except that a firing temperature of 250° C. was employed in the second step of Example 1-1. The reaction was not fully completed in the obtained aluminum metaphosphate.

### Comparative Example 1-1

In the second step of Example 1-1, the reaction mixture containing aluminum biphosphate obtained in the first step was transferred to a vacant metal aluminum firing vessel on which aluminum metaphosphate powder was not spread, and subjected to firing. The obtained lump of aluminum metaphosphate stuck on the firing vessel, and was not able to be removed. Thus, the stuck substance was shaved by a stainless spoon to thereby obtain aluminum metaphosphate.

### Comparative Example 1-2

345.9 g of phosphoric acid (product of Nippon Chemical Industrial Co., Ltd., concentration of H₃PO₄:85 wt. %, pure phosphoric acid) was charged into a 2-liter beaker, and 51 g of α-alumina was added thereto. The molar ratio calculated on the basis of P₂₀₅ and Al₂O₃ (P₂O₅/Al₂O₃) was 3.00:1. Water was not added in this case. The beaker was heated by use of an electric heater to initiate the reaction. The temperature of the solution increased to about 130° C. due to the heat of reaction. This state was maintained for 30 minutes. Aluminum biphosphate was produced through the reaction. The aluminum biphosphate was caked in the beaker, and was hard to remove.

(Performance Evaluation)

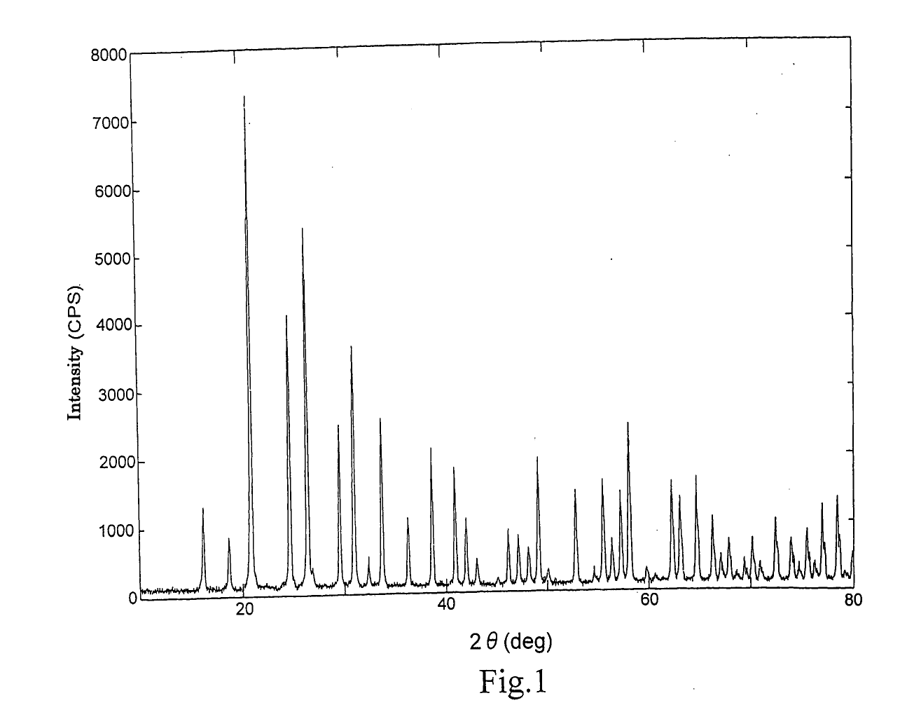

The aluminum metaphosphate obtained in each of the Examples and Comparative Examples was measured for the content of coloring metal elements by means of the above-described method. Also, the purity of the aluminum metaphosphate (the content of P₂O₅ and Al₂O₃) was determined through the method described in Purity measurement (1) below. Further, the content of free phosphoric acid in the aluminum metaphosphate and the ignition loss were determined. Further, the molar ratio (P₂O₅/Al₂O₃) in the aluminum metaphosphate was determined. The results are shown in Table 1. Moreover, the crystal structure of the aluminum metaphosphate powder obtained in Example 1-1 was determined by means of an X-ray diffractometer. The results are shown in FIG. 1. The measurement conditions were: a Cu Kα radiation source, a scan speed of 4°/min, and a scan range 2θ=5 to 60°.

(Purity Measurement (1))

(1) Content of P₂O₅

a. Weighing 1 g of sample precisely into a 200-ml quartz beaker.

b. Adding 30 ml of an aqueous solution of sodium hydroxide (20 wt/vol %).

c. Covering with a watch glass and heating on an electric heater to dissolve.

d. Cooling to room temperature, adding 18 ml of hydrochlolic acid, and heating. Adding a small amount of pure water if crystals are precipitated upon adding the hydrochloric acid.

e. After cooling to room temperature, transferring to a 250-ml volumetric flask, adding water up to the mark, and shaking well to allow mixing.

f. Removing 25 ml to a 250-ml volumetric flask, adding water up to the mark, and shaking well to allow mixing, to thereby obtain a test solution.

g. Removing 20 ml of the test solution to a 100-ml volumetric flask. At the same time, removing 10 ml of a first solution of a diphosphorus pentaoxide standard solution (1 ml=0.58 mg P₂O₅) and 10 ml of a second solution of a diphosphorus pentaoxide standard solution (1 ml=0.66 mg P₂O₅) to respective 100-ml volumetric flasks. Adding pure water to each of the samples to about 30 ml.

h. Adding 4 ml of nitric acid (1+1), and heating on a hot plate (about 170° C.) for 15 minutes.

i. Adding water for adjusting the solution volume to about 70 ml, and cooling in a water bath for about 20 minutes.

j. Adding 20 ml of an ammonium vanadomolybdate coloring reagent, adding water up to the mark, shaking well to allow mixing, and allowing to stand for 30 minutes.

k. Performing cell correction with the first standard solution as a control solution by use of a spectrophotometer (420 nm, cell: 20 mm), and then reading the transmittance of the sample solution and the second standard solution down to the first decimal place. Determining the absorbancy from the transmittance.

l. Determining the content (%) of P₂O₅ down to the second decimal place by use of the following equation:

$${P}_{2} {O}_{5} ( \% ) = \frac{( A / B \times 0.8 + 5.8 ) \times 100}{Sample ( g ) \times 25 / 500 \times 10 / 250 \times 100} \times 100$$

wherein A represents the absorbancy of the sample, and B represents the absorbancy of the second standard solution.

(2) Content of Al₂O₃

a. Employing the test solution decomposed and prepared upon measuring the content of diphosphorus pentaoxide.

b. Removing 20 ml of the test solution to each of three 100-ml volumetric flasks.

c. Adding 3 ml of hydrochlolic acid (1+1) to the first volumetric flask, and adding water up to the 100-ml mark.

d. Adding 3 ml of hydrochlolic acid (1+1) to the second volumetric flask, adding 5 ml of an Al standard solution (100 ppm), and then adding water up to the 100-ml mark.

e. Adding 3 ml of hydrochlolic acid (I+1) to the third volumetric flask, adding 10 ml of the Al standard solution (100 ppm), and then adding water up to the 100-ml mark.

f. Determining the Al concentration (ppm) in the sample solution by means of an ICP standard addition method (wavelength: 396.152 nm).

g. Determining the Al₂O₃ content (%) down to the second decimal place by use of the following equation:

$${Al}_{2} {O}_{3} ( \% ) = \frac{Al concentration ( ppm ) \times 100 / 1000 \times 1.8895 \times 100}{Sample ( g ) \times 25 / 500 \times 20 / 250 \times 1000}$$

(Measurement of Free Phosphoric Acid Content)

a. Weighing 2 g of sample precisely into a 250-ml volumetric flask, and adding about 150 ml of water.

b. Heating the volumetric flask on a hot plate for about 5 minutes. After cooling, adding water to the volumetric flask to the mark, and shaking well to allow mixing.

c. Filtrating the solution in the volumetric flask through a dry filter paper (No. 5C).

d. Removing 100 ml of the filtrate to a 300-ml conical beaker by use of a transfer pipet.

e. Adding a few drops of a methyl orange/indigo carmine mixed indicator to the conical beaker, and titrating with a sodium hydroxide standard solution (N/10). The end point is a point when the solution color changes from purple to lead-gray.

f. Determining the free phosphoric acid content (%) down to the second decimal place by use of the following equation:

$$Free phosphoric acid ( \% ) = \frac{Titer ( ml ) \times ( Normality of N / 10 NaOH ) \times 0.007097}{Sample ( g ) \times 100 / 250} \times 100$$

(Ignition Loss)

a. Placing 5 g of sample in a porcelain crucible of known weight, and precisely weighing with a precision of 0.1 mg.

b. Placing the crucible in an electric furnace maintained at 500° C. to ignite for 1 hour.

c. Removing the crucible from the electric furnace, allowing to cool in a desiccator, and precisely measuring the weight of the sample with a precision of 0.1 mg.

d. Determining the ignition loss (%) from the measured value by use of the following equation down to the second decimal place:

$$Ignition loss = \frac{Weight loss ( g )}{Sample ( g )} \times 100$$

(Molar Ratio (P₂O₅/Al₂O₃))

The evaluation is performed by use of the following equation:

$$Molar ratio ( {P}_{2} {O}_{5} / {Al}_{2} {O}_{3} ) = \frac{{P}_{2} {O}_{5} content ( \% )}{{Al}_{2} {O}_{3} content ( \% )} \times 0.7183$$

TABLE 1

| | | | | | | | Comparative | |
|---|---|---|---|---|---|---|---|---|
| | Examples | | | | | | Example | |
| | 1-1 | 1-2 | 1-3 | 1-4 | 1-5 | 1-6 | 1-1 | 1-2 |
| P₂O₅ content (wt. %) | 80.09 | 79.23 | 80.02 | 79.99 | 79.99 | 70.76 | 80.09 | — |
| Al₂O₃ content (wt. %) | 18.95 | 18.87 | 18.78 | 19.03 | 19.81 | 16.74 | 18.95 | — |
| Purity (wt. %) | 99.04 | 98.1 | 98.8 | 99.02 | 99.8 | 87.5 | 99.04 | — |
| Molar ratio (P₂O₅/Al₂O₃) | 3.04 | 3.02 | 3.06 | 3.02 | 2.9 | 3.04 | 3.04 | — |
| Free phosphoric acid (wt. %) | 0.06 | 0 | 0.22 | 0.63 | 0 | 3.58 | 0.06 | — |
| Ignition loss (wt. %) | 0.24 | 0.1 | 0.2 | 0.89 | 0.16 | 11.2 | 0.24 | — |
| Iron (ppm) | 1.5 | 1.5 | 2.2 | 0.9 | 3.1 | 0.8 | 4.4 | — |
| Chromium (ppm) | 0.5 | 0.5 | 0.5 | 0.7 | 4.4 | 0.1 | 6.2 | — |
| Manganese (ppm) | 0.1 | 0.1 | 0.1 | 0.1 | 0.1 | 0.1 | 0.2 | — |
| Nickel (ppm) | 0.1 | 0.1 | 0.2 | 0.8 | 0.1 | 0.1 | 0.6 | — |
| Copper (ppm) | 0.1 | 0.1 | 0.1 | 0.1 | 0.1 | 0.1 | 0.1 | — |

### Example 2-1

624 g of high purity aluminum hydroxide and 774 g of anhydrous phosphoric acid (product of Nippon Chemical Industrial Co., Ltd.) were charged into a 3 L mortar mixer and allowed to mix for 5 minutes. Subsequently, 1105 g of polyphosphoric acid (trade name: Polyphosphoric acid 116T, product of Nippon Chemical Industrial Co., Ltd.) was added thereto and allowed to mix for 5 minutes. The molar ratio (P₂O₅/Al₂O₃) calculated on the basis of P₂O₅ and Al₂O₃ was 3.00. The obtained mixture was a rice-cake-like kneaded substance. The rice-cake-like kneaded substance was transferred to a metal aluminum firing vessel on which aluminum metaphosphate powder was spread in advance. The firing vessel containing the rice-cake-like kneaded substance was placed in an electric furnace, heated to 550° C., and then held at this temperature for 4 hours for firing. Upon completion of the firing, the firing vessel was cooled to obtain a lump of aluminum metaphosphate. The obtained lump of aluminum metaphosphate was pulverized by means of a pulverizer to obtain aluminum metaphosphate powder.

### Examples 2-2 to 2-5

The same procedure as in Example 2-1 was followed to obtain aluminum metaphosphate powder, except that the charging molar ratio, P₂O₅/Al₂O₃, was changed to 2.9 (Example 2-2), 2.8 (Example 2-3), 2.7 (Example 2-4), and 2.6 (Example 2-5).

### Example 2-6

The same procedure as in Example 2-1 was followed, except that the aluminum metaphosphate powder obtained in Example 2-1 was washed with pure water and dried in a dryer.

### Example 2-7

The same procedure as in Example 2-1 was followed to obtain aluminum metaphosphate powder, except that the firing time was reduced to 2 hours.

### Example 2-8

The same procedure as in Example 2-1 was followed to obtain aluminum metaphosphate powder, except that the charging amount of anhydrous phosphoric acid was changed to 463 g and the charging amount of polyphosphoric acid was changed to 1473 g. The molar ratio (P₂O₅/Al₂O₃) was 3.00 as in Example 2-1.

### Example 2-9

624 g of high purity aluminum hydroxide and 774 g of anhydrous phosphoric acid (product of Nippon Chemical Industrial Co., Ltd.) were charged into a 3 L mortar mixer and allowed to mix for 5 minutes. Subsequently, 1185 g of polyphosphoric acid (trade name: Polyphosphoric acid 116T, product of Nippon Chemical Industrial Co., Ltd.) was added thereto and allowed to mix for 5 minutes. The molar ratio (P₂O₅/Al₂O₃) calculated on the basis of P₂O₅ and Al₂O₃ was 3.12. The obtained mixture was a rice-cake-like kneaded substance. The rice-cake-like kneaded substance was transferred to a metal aluminum firing vessel on which aluminum metaphosphate powder was spread in advance. The firing vessel containing the rice-cake-like kneaded substance was placed in an electric furnace, heated to 550° C., and then held at this temperature for 2 hours for firing. Upon completion of the firing, the firing vessel was cooled to obtain a lump of aluminum metaphosphate. The obtained lump of aluminum metaphosphate was pulverized by means of a pulverizer to obtain aluminum metaphosphate powder.

### Comparative Example 2-1

624 g of high purity aluminum hydroxide and 1704 g of anhydrous phosphoric acid (product of Nippon Chemical Industrial Co., Ltd.) were charged into a 3 L mortar mixer and allowed to mix for 5 minutes. Subsequently, 175 g of pure water was added. The anhydrous phosphoric acid was reacted vigorously with the pure water to generate gas. Thus, the rice-cake-like kneaded substance was not formed.

### Comparative Example 2-2

The rice-cake-like kneaded substance was transferred to an empty metal aluminum firing vessel on which aluminum metaphosphate powder was not spread, and was subjected to firing. The obtained lump of aluminum metaphosphate stuck to the firing vessel, and was not able to remove.

(Performance Evaluation)

The aluminum metaphosphate obtained in each of the Examples and Comparative Examples was measured for the content of coloring metal elements by means of the above-described method. Also, the purity of the aluminum metaphosphate (the content of P₂O₅ and Al₂O₃) was determined by the method described in Purity measurement (2) below. Further, the molar ratio (P₂O₅/Al₂O₃) in the aluminum metaphosphate was determined. Further, the content of free phosphoric acid in the aluminum metaphosphate and the ignition loss were determined by means of the above-described method. The results are shown in Table 2.

(Purity Measurement (2))

In the measurement of the purity of the aluminum metaphosphate, P₂O₅ (wt. %) and Al₂O₃ (wt. %) were determined separately, and these were summed to evaluate the purity of the aluminum metaphosphate. The procedure for the determination is as follows. In the case of P₂O₅ (wt. %), the determination can be performed by means of a colorimetric method through mixing with ammonium vanadate and ammonium molybdate. In the case of Al₂O₃ (wt. %), the determination can be performed by means of a combination of ICP emission spectroscopy and a gravimetric method.

(1) Content of P₂₀₅

a. Weighing 5 g of sample precisely into a 500-ml glass beaker.

b. Adding 150 ml of an aqueous solution of sodium hydroxide (20 W/V %) to the glass beaker.

c. Subjecting the glass beaker to an electric heater to heat and dissolve the solution, and heating for 7 minutes after boiling.

d. Cooling to room temperature, adding 90 ml of hydrochloric acid, heating until boiling, and maintaining this state for 2 minutes after boiling. If crystals are precipitated during this operation, a small amount of water is added to dissolve the crystals.

e. After cooling to room temperature, filtrating the solution contained in the glass beaker into a 500-ml volumetric flask by use of a filter paper (No. 2). Repeatedly washing the glass beaker until the volume of the solution becomes about 300 ml. Subsequently, washing the glass beaker with 5 ml of hydrochloric acid (1+1), and washing the filter paper employed for filtration with 3 ml of hydrochloric acid (1+1). Subsequently, washing with pure water, transferring, adding pure water to the volumetric flask up to the mark, and shaking well to allow mixing.

f. Performing the above operations a to e also for a blank.

g. Removing 25 ml of the filtrate to a 500 ml volumetric flask, adding water up to the mark, and shaking well to allow mixing, to thereby obtain a test solution.

h. Preparing 10 ml of a first solution of a diphosphorus pentaoxide standard solution (1 ml=0.58 mg P₂O₅) and 10 ml of a second solution of a diphosphorus pentaoxide standard solution (1 ml=0.66 mg P₂O₅). In addition to these solutions, removing 10 ml of the test solution to a 100-ml volumetric flask, and adding water to about 30 ml.

h. Adding 4 ml of nitric acid (1+1) to the volumetric flask, and heating on a hot plate for 15 minutes.

i. Adding water to the volumetric flask for adjusting the solution volume to about 70 ml, and cooling in a water bath for about 20 minutes.

j. Adding 20 ml of a coloring reagent to the volumetric flask, adding water up to the mark, shaking well to allow mixing, and allowing to stand for 30 minutes. This solution serves as a sample solution.

k. Performing cell correction with the first standard solution as a control solution by use of a spectrophotometer (420 nm, cell: 20 mm), and then reading the transmittance of the sample solution and the second standard solution down to the first decimal place. Determining the absorbancy from the transmittance.

l. Determining the content (%) of diphosphorus pentaoxide (P₂O₅) down to the second decimal place by use of the following equation:

$${P}_{2} {O}_{5} ( \% ) = \frac{( A / B \times 0.8 + 5.8 ) \times 100}{Sample ( g ) \times 25 / 500 \times 10 / 250 \times 100} \times 100$$

wherein A is the absorbancy of the sample, and B is the absorbancy of the second standard solution.
(2a) Content of Al₂O₃ (ICP Method)

a. Employing the test solution decomposed and prepared upon measuring the content of diphosphorus pentaoxide.

b. Removing 5 ml of the test solution to each of two 100-ml volumetric flasks.

c. Adding water to one volumetric flask up to the 100-ml mark. This solution serves as a sample solution.

d. Adding 5 ml of an Al standard solution (100 ppm) to the other volumetric flask, and then adding water up to the 100-ml mark.

e. Determining the Al concentration (ppm) in the sample solution by means of an ICP standard addition method (wavelength: 396.152 nm).

f. Determining the Al₂O₃ content (%) down to the second decimal place by use of the following equation:

$${Al}_{2} {O}_{3} ( \% ) = \frac{Al concentration ( ppm ) \times 100 / 1000 \times 1.8895 \times 100}{Sample ( g ) \times 25 / 500 \times 20 / 250 \times 1000}$$

(2b) Content of Al₂O₃ (Gravimetric Method)

a. Placing the filter paper employed for filtration upon decomposing and preparing for measuring the content of diphosphorus pentaoxide and the filter paper for the blank in respective porcelain crucibles of known weight, and heating in an electric heater at 800° C. for 40 minutes for incineration. After the incineration, measuring the weight of each crucible.

b. Determining the aluminum oxide (Al₂O₃) content (%) down to the second decimal place by use of the following equation:

$${Al}_{2} {O}_{3} ( \% ) = \frac{X}{Sample ( g )} \times 100$$

wherein X represents (the crucible weight after the sample is incinerated (g)−the crucible weight before the sample is incinerated (g))−(the crucible weight after the blank is incinerated (g)−the crucible weight before the blank is incinerated (g)).
(Molar Ratio (P₂O₅/Al₂O₃))

The evaluation is performed by use of the following equation:

$$Molar ratio ( {P}_{2} {O}_{5} / {Al}_{2} {O}_{3} ) = \frac{{P}_{2} {O}_{5} ( \% )}{( {Al}_{2} {O}_{3} ( \% ) ( ICP method ) + {Al}_{2} {O}_{3} ( \% ) ( Gravimetric method )} \times 0.7183$$

TABLE 2

| | | | | | | | | | | Comparative | |
|---|---|---|---|---|---|---|---|---|---|---|---|
| | Examples | | | | | | | | | Example | |
| | 2-1 | 2-2 | 2-3 | 2-4 | 2-5 | 2-6 | 2-7 | 2-8 | 2-9 | 2-1 | 2-2 |
| P₂O₅ content (wt. %) | 79.04 | 78.64 | 78.25 | 77.11 | 76.95 | 78.8 | 78.64 | 78.72 | 79.95 | — | — |
| Al₂O₃ content (wt. %) | 18.74 | 19.01 | 19.58 | 19.76 | 19.85 | 18.84 | 18.19 | 18.82 | 18.18 | — | — |
| Purity (wt. %) | 97.78 | 97.65 | 97.83 | 96.87 | 96.8 | 97.64 | 96.83 | 97.54 | 98.13 | — | — |
| Molar ratio (P₂O₅/Al₂O₃) | 2.98 | 2.9 | 2.78 | 2.7 | 2.59 | 2.99 | 3.02 | 2.98 | 3.14 | — | — |
| Free phosphoric acid (wt. %) | 1.03 | 0.46 | 0.33 | 0 | 0.13 | 0 | 1.35 | 0.93 | 2.56 | — | — |
| Ignition loss (wt. %) | 1.42 | 0.41 | 0.23 | 0.07 | 0.21 | 0.16 | 1.42 | 1.02 | 3.58 | — | — |
| Iron (ppm) | 1.1 | 1.8 | 1.7 | 2.1 | 1.4 | 1.1 | 2.3 | 1.8 | 2.3 | — | — |
| Chromium (ppm) | 2.5 | 0.1 | 0.1 | 0.1 | 0.1 | 2.1 | 2.5 | 2.5 | 0.2 | — | — |
| Manganese (ppm) | 0.1 | 0.3 | 0.2 | 0.3 | 0.4 | 0.1 | 0.1 | 0.1 | 0.3 | — | — |
| Nickel (ppm) | 0.1 | 0.1 | 0.1 | 0.1 | 0.1 | 0.1 | 0.1 | 0.4 | 0.1 | — | — |
| Copper (ppm) | 0.1 | 0.1 | 0.1 | 0.3 | 0.6 | 0.1 | 0.1 | 0.1 | 0.1 | — | — |

### Example 3-1

(1) First Step

588.0 g of phosphoric acid (product of Nippon Chemical Industrial Co., Ltd., concentration of H₃PO₄:89 wt. %, pure phosphoric acid) was charged into a 2-liter reaction vessel, and then 526.9 g of high purity barium carbonate was added thereto. The molar ratio calculated on the basis of P₂O₅ and BaO(P₂O₅/BaO) was 1.00. The vessel was heated by use of an electric heater to initiate the reaction. The reaction was allowed to proceed for 60 minutes to thereby obtain a granular reaction product.

(2) Second Step

The reaction mixture obtained in the first step was transferred to a metal aluminum firing vessel on which barium metaphosphate powder was spread in advance. The firing vessel was placed in an electric furnace and heated up to 550° C. This temperature was maintained for 4 hours for firing. Upon completion of the firing, the fired product was cooled to obtain a lump of barium metaphosphate.

(3) Third Step

The lump of barium metaphosphate obtained in the second step was pulverized in an alumina mortar to thereby obtain barium metaphosphate powder.

### Examples 3-2 to 3-4

The same procedure as in Example 3-1 was followed to obtain barium metaphosphate powder, except that the molar ratio (P₂O₅/BaO) upon charging was changed to 0.97 (Example 3-2), 0.95 (Example 3-3), and 0.90 (Example 3-4).

### Example 3-5

The same procedure as in Example 3-1 was followed to obtain barium metaphosphate powder, except that a firing temperature of 250° C. was employed.

### Comparative Example 3-1

In the second step of Example 3-1, the reaction product obtained in the first step was transferred to an empty metal aluminum firing vessel on which barium metaphosphate powder was not spread, and was subjected to firing. The obtained lump of aluminum metaphosphate stuck to the firing vessel, and was not able to remove.

(Performance Evaluation)

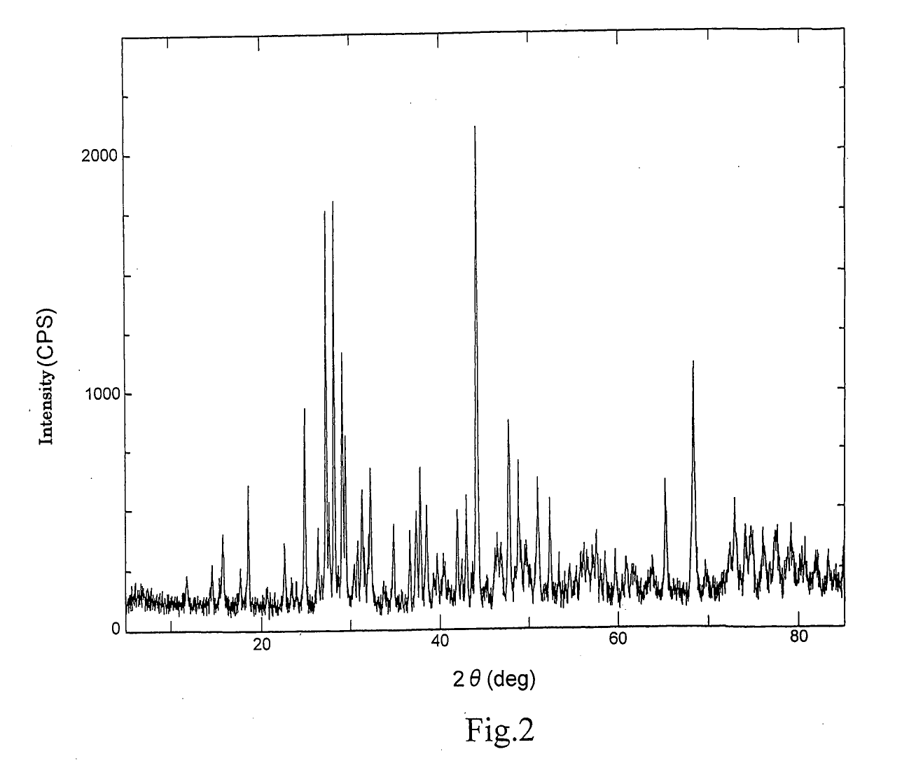

The barium metaphosphate obtained in each of the Examples and Comparative Example was measured for the content of coloring metal elements by means of the above-described method. Also, the purity of the barium metaphosphate (the content of P₂O₅ and BaO) was determined by the method described in Purity measurement (3) below. Further, the molar ratio (P₂O₅/BaO) in the barium metaphosphate was determined. Further, the content of free phosphoric acid in the barium metaphosphate and the ignition loss were determined by means of the above-described method. The results are shown in Table 3. Moreover, the crystal structure of the barium metaphosphate powder obtained in Example 3-1 was determined by means of an X-ray diffractometer. The results are shown in FIG. 2. The measurement conditions were: a Cu Kα radiation source, a scan speed of 4°/min, and a scan range 2θ=5 to 60°.

(Purity Measurement (3) (Content of P₂₀₅ and BaO))

(1) Content of P₂O₅

a. Precisely weighing about 1 g of sample with a precision of 0.1 mg by means of an electronic balance, and placing in a 250-ml volumetric flask. Adding 10 ml of perchloric acid, heating and decomposing until the solution develops a yellow color. After cooling, adjusting the volume with pure water, and mixing well to obtain a test solution.

b. Removing 2 ml of the test solution to a 100-ml volumetric flask by use of a transfer pipet, adding 4 ml of nitric acid (1+1), and adjusting the solution volume to 70 ml with pure water.

c. Heating and boiling on a hot plate for about 15 minutes, and then cooling in a water bath (20±1° C.) for about 20 minutes.

d. After cooling, adding 20 ml of an ammonium vanadomolybdate coloring reagent, adjusting the volume with pure water, mixing well, and allowing to stand for 30 minutes.

e. For a first phosphoric acid standard solution (0.37 mg/ml on the basis of P₂O₅) and a second solution (0.43 mg/ml on the basis of P₂O₅), removing 10 ml of each standard solution to respective 100-ml volumetric flasks, and allowing to develop color as in the sample.

f. After allowing to stand for 30 minutes, performing a measurement by use of a spectrophotometer (measurement wavelength: 430 nm, cell: 25 mm). A cell correction is carried out by use of the first phosphoric acid standard solution.

g. Determining the content of P₂O₅ (%) down to the second decimal place by use of the following equation:

$${P}_{2} {O}_{5} ( \% ) = \frac{( 3.7 + 0.6 / A \times B )}{S}$$

wherein A represents the absorbancy of the second phosphoric acid standard solution, B represents the absorbancy of the test sample, and S represents the collected amount of the sample (mg).

(2) Content of BaO

a. Precisely weighing about 1 g of sample with a precision of 0.1 mg by means of an electronic balance, and placing in a 250-ml volumetric flask.

b. Adding 10 ml of perchloric acid, heating and decomposing until the solution develops a yellow color. After cooling, adjusting the volume with pure water, and mixing well to obtain a test solution.

c. Removing 100 ml of the test solution to a 300-ml beaker by use of a transfer pipet, and adjusting the solution volume to 150 ml with pure water.

d. After heating and boiling on an electric heater, adding 10 ml of sulfuric acid (1+1), stirring well, and allowing to stand for 4 hours.

e. After allowing to stand, filtrating with a filter paper (No. 5C), and washing well with warm water.

f. Placing the precipitate to a porcelain crucible of known weight together with the filter paper, and incinerating with care such that the filter paper does not burn on the electric heater.

g. After the incineration, placing the porcelain crucible in an electric furnace adjusted to 800° C., and igniting for 40 minutes.

h. After the ignition, transferring the porcelain crucible to a desiccator, and allowing to cool to room temperature.

i. After allowing to cool, precisely weighing the porcelain crucible with a precision of 0.1 mg by use of an electronic balance for determining the remaining weight.

j. Evaluating the BaO content (%) by use of the equation below. The value is calculated down to the third decimal place, and is represented by rounding to two decimal places.
BaO Content(%)=Barium sulfate weight (Remaining weight(g)×0.65697×250
(Molar Ratio (P₂O₅/BaO))

The evaluation is performed by use of the following equation:

$$Molar ratio ( {P}_{2} {O}_{5} / Ba O ) = \frac{{P}_{2} {O}_{5} content ( \% )}{BaO content ( \% )} ⨯ 1.0803$$

TABLE 3

| | | | | | | Comparative |
|---|---|---|---|---|---|---|
| | Examples | | | | | Example |
| | 3-1 | 3-2 | 3-3 | 3-4 | 3-5 | 3-1 |
| P₂O₅ content | 48.1 | 47.56 | 47.17 | 45.94 | 46.18 | — |
| (wt. %) | | | | | | |
| BaO content | 51.65 | 52.81 | 52.85 | 53.93 | 50.27 | — |
| (wt. %) | | | | | | |
| Purity (wt. %) | 99.75 | 100.37 | 100.02 | 99.87 | 96.45 | — |
| Molar ratio | 1.01 | 0.97 | 0.96 | 0.92 | 0.99 | — |
| (P₂O₅/BaO) | | | | | | |
| Free phosphoric | 0.41 | 0 | 0 | 0 | 2.95 | — |
| acid (wt. %) | | | | | | |
| Ignition loss | 0.71 | 0.07 | 0.15 | 0.34 | 2.89 | — |
| (wt. %) | | | | | | |
| Iron (ppm) | 2 | 2 | 1.4 | 1.4 | 1 | — |
| Chromium (ppm) | 1.5 | 1.1 | 1.8 | 1.8 | 0.9 | — |
| Manganese | 0.2 | 0.3 | 0.2 | 0.1 | 0.1 | — |
| (ppm) | | | | | | |
| Nickel (ppm) | 3.3 | 3 | 1.6 | 3.3 | 2.2 | — |
| Copper (ppm) | 0.5 | 0.4 | 0.2 | 0.2 | 0.3 | — |

### Example 4-1

(1) First Step

1844.8 g of phosphoric acid (product of Nippon Chemical Industrial Co., Ltd., concentration of H₃PO₄:85%, pure phosphoric acid) was charged into a 2 -liter beaker, and 651.2 g of zinc oxide (product of TOHO ZINC Co., Ltd, Ginrei A) was added thereto. Zinc oxide sieved with a sieve having an aperture of 1 mm in advance was employed. The molar ratio of zinc oxide to phosphoric acid (the former: the latter) was 1:2. By adding zinc oxide, the solution temperature was increased to about 120° C. due to the heat of reaction. The reaction vessel was heated to 180° C. to remove water generated through the reaction. Subsequently, the reaction product was transferred to a Teflon (registered trademark) vessel, and cooled to room temperature in the vessel to thereby obtain a glassy solidified substance (zinc biphophate).

(2) Second Step

The solidified substance of zinc biphosphate obtained in the first step was transferred to and filled in an alumina firing vessel on which zinc metaphosphate powder was spread in advance. The firing vessel was placed in an electric furnace and heated from room temperature to 600° C. at a temperature increase rate of 5° C./min. This temperature was maintained for 3 hours for firing. Upon completion of the firing, the fired product was cooled to obtain a lump of zinc metaphosphate. The obtained lump of zinc metaphosphate was pulverized by means of a pulverizer to thereby obtain zinc metaphosphate powder.

### Examples 4-2 and 4-3

The same procedure as in Example 4-1 was followed to obtain zinc metaphosphate powder, except that a cordierite firing vessel (Example 4-2) and an aluminum firing vessel (Example 4-3) were employed in place of the firing vessel employed in the second step of Example 4-1.

### Comparative Example 4-1

The same procedure as in Example 4-1 was followed, except that a firing temperature of 300° C. was employed in the second step of Example 4-1. Since dehydration was not completed in the obtained zinc metaphosphate, the measurement of impurities and the purity was unable to be performed.

### Comparative Example 4-2

In the second step of Example 4-3, the glassy solidified substance was transferred to an empty metal aluminum firing vessel on which zinc metaphosphate powder was not spread, and was subjected to firing. The obtained zinc metaphosphate was a very hard lump stuck to the firing vessel, and was hard to remove.

(Performance Evaluation)

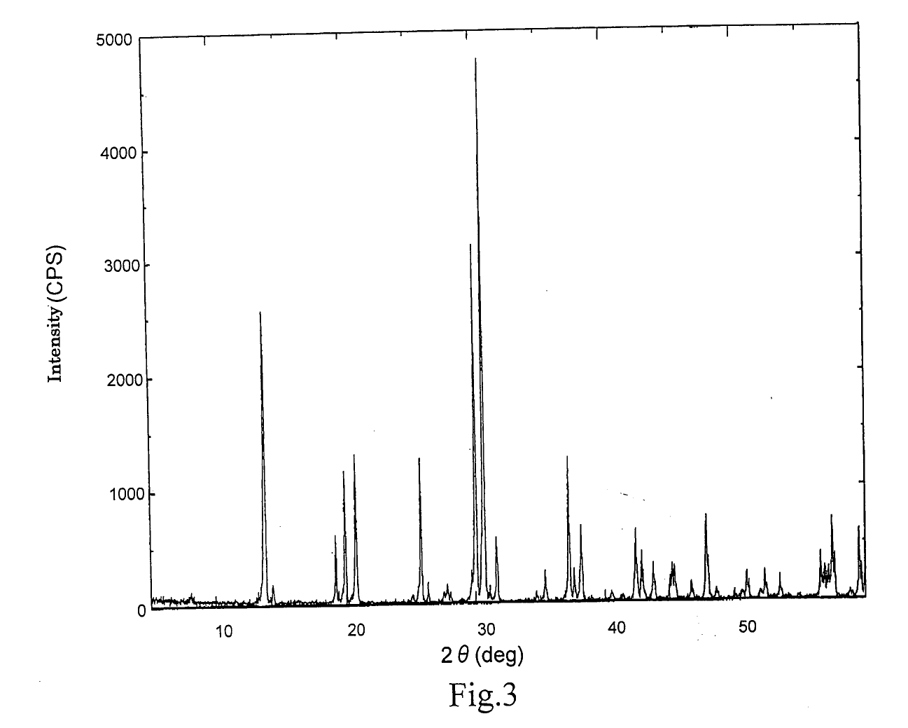

The zinc metaphosphate obtained in each of the Examples and Comparative Examples was measured for the content of coloring metal elements by means of the above-described method. Also, the purity of the zinc metaphosphate (the content of P₂O₅ and ZnO) was determined by the method described in Purity measurement (4) below. Further, the molar ratio (P₂O₅/ZnO) in the zinc metaphosphate was determined. Further, the content of free phosphoric acid in the zinc metaphosphate and the ignition loss were determined by means of the above-described method. The results are shown in Table 4 below. Moreover, the crystal structure of the zinc metaphosphate powder obtained in Example 4-1 was determined by means of an X-ray diffractometer. The results are shown in FIG. 3. The measurement conditions were: a Cu Kα radiation source, a scan speed of 4°/min, and a scan range 2θ=5 to 60°.

(Purity Measurement (4))

In the measurement of the purity of the zinc metaphosphate, the content of P₂O₅ and the content of ZnO were determined separately, and these were summed to evaluate the purity of the zinc metaphosphate. The procedure for the determination is as follows. 10.0 g of the obtained zinc metaphosphate powder was weighed into a Teflon (registered trademark) vessel. 100 ml of 20% NaOH solution was added thereto, and then the zinc metaphosphate powder was fully dissolved by heating and stirring for 30 minutes by use of a magnetic stirrer having an electric heater. This solution was cooled to room temperature, and then 60 ml of concentrated hydrochloric acid was gradually added thereto. The solution was brought to the boil and stirred while heating for 30 minutes by use of the abovementioned stirrer. The solution was again cooled to room temperature and then transferred to a 250-ml volumetric flask, and deionized water was added up to the mark. This solution (hereinafter referred to as A) was employed for determining each of the purities. The content of ZnO and the content of P₂₀₅ were determined by means of the following methods.

(1) Content of ZnO

a. Taking 5 ml of the solution A in a conical beaker, and adding 25 ml of an M/20 EDTA standard solution thereto.

b. Adding 20 ml of a 2M sodium acetate buffer solution, adding deionized water to 150 ml, and adding aqueous ammonia to a pH of about 5.8.

c. Adding five drops of a xylenol orange indicator. This solution serves as a test solution.

d. Titrating with an M/20 zinc standard solution, and defining the end point as the point at which the disappearance of a light red color is retarded and the light red color is maintained for 30 seconds.

e. Performing a blank test by employing the same procedure as in the operations a to d except that solution A is not added in a. The content of zinc oxide is determined by the following equation:

$$ZnO ( \% ) = \frac{( B - A ) ⨯ f ⨯ 20.348}{S}$$

wherein A represents the titer (ml) in the test solution, B represents the titer (ml) in the blank test, f represents the factor of the zinc standard solution, and S represents the weight of the sample.
(2) Content of P₂₀₅

a. Taking 10 ml of solution A, and adding pure water up to the mark of a 500-ml volumetric flask to adjust the volume.

b. Taking 10 ml of the prepared solution in a 100-ml volumetric flask, and adding pure water to about 30 ml.

c. Adding 4 ml of nitric acid, heating to boil on a heater, and then heating for 5 minutes.

d. After water cooling, adding pure water to about 70 ml.

e. Adding 20 ml of ammonium vanadomolybdate while stirring the solution obtained in d.

f. Adding pure water up to the mark to adjust the volume, and allowing to stand for 30 minutes. This solution serves as a test solution.

g. Measuring the absorbancy of the test solution by means of the following method under the measurement conditions of λ=430 nm, cell=20 mm glass cell, and measurement time=60 sec: performing cell correction with a diphosphorus pentaoxide first standard solution as a control solution; and subsequently measuring the absorbancy of the test solution and a diphosphorus pentaoxide second standard solution. The content of P₂O₅ is determined by use of the following equation:

$${P}_{2} {O}_{5} ( \% ) = ( \frac{0.2}{A} ⨯ B + C ) ⨯ 100 ⨯ 22.9136 / S$$

wherein A represents the absorbancy of the diphosphorus pentaoxide second standard solution, B represents the absorbancy of the test solution, C represents the weight of P contained in the diphosphorus pentaoxide first standard solution, and S represents the weight of the sample.

The diphosphorus pentaoxide standard solutions are prepared according to the following method: placing 10 and 11 ml of a 0.458 mg/ml diphosphorus pentaoxide solution in respective 100-ml volumetric flasks; adding 50 ml of pure water; adding 20 ml of a coloring reagent while stirring; adding pure water up to the mark to adjust the volume; and allowing to stand for 30 minutes. The obtained solutions serve as the diphosphorus pentaoxide first standard solution (containing 0.0458 mg/ml of diphosphorus pentaoxide) and the diphosphorus pentaoxide second standard solution (containing 0.0504 mg/ml of diphosphorus pentaoxide), respectively.

(Molar Ratio P₂O₅/ZnO)

The molar ratio is evaluated by use of the following equation:

$$Molar ratio ( {P}_{2} {O}_{5} / ZnO ) = \frac{{P}_{2} {O}_{5} content ( \% )}{ZnO content ( \% )} ⨯ 0.573$$

TABLE 4

| | | | | Comparative | |
|---|---|---|---|---|---|
| | Example | | | Example | |
| | 4-1 | 4-2 | 4-3 | 4-1 | 4-2 |
| P₂O₅ content (wt. %) | 63.0 | 62.8 | 62.9 | — | 62.5 |
| ZnO content (wt. %) | 36.3 | 36.4 | 35.9 | — | 35.5 |
| Purity (wt. %) | 99.3 | 99.2 | 98.8 | — | 98.0 |
| Molar ratio (P₂O₅/ZnO) | 1.00 | 1.01 | 1.02 | | 1.01 |
| Free phosphoric acid (wt. %) | 0 | 0 | 0.58 | | — |
| Ignition loss (wt. %) | 0.12 | 0.66 | 1.26 | | — |
| Iron (ppm) | 0.3 | 5.0 | 2.6 | — | 7.5 |
| Chromium (ppm) | <0.3 | <0.3 | <0.3 | — | 0.3 |
| Manganese (ppm) | <0.2 | <0.1 | <0.1 | — | 0.1 |
| Nickel (ppm) | <2.3 | <2.3 | <2.3 | — | 2.3 |
| Copper (ppm) | 0.7 | <0.3 | <0.3 | — | 0.3 |

### Example 5-1

(1) First Step

230.7 g of phosphoric acid (product of Nippon Chemical Industrial Co., Ltd., concentration of H₃PO₄:85%, pure phosphoric acid) was charged into a 500-ml beaker, and 174.1 g of a calcium hydroxide slurry was added thereto at a rate of 5 ml/min while water cooling. The calcium hydroxide slurry employed was prepared by dispersing 74.1 g of calcium hydroxide (product of Ube Material Industries, Ltd., CQH) into 100 g of deionized water. The molar ratio of calcium hydroxide to phosphoric acid (the former: the latter) was 1:2. After the addition of the entire volume of the calcium hydroxide slurry, the reaction vessel was heated to 140° C. to allow the reaction to proceed for 30 minutes, thereby obtaining a white viscous rice-cake-like substance.

(2) Second Step

The rice-cake-like substance obtained in the first step was transferred to and filled in an alumina firing vessel on which calcium metaphosphate powder was spread in advance. The firing vessel was placed in an electric furnace and heated from room temperature to 550° C. at a temperature increase rate of 5° C./min. This temperature was maintained for 3 hours for firing. Upon completion of the firing, the fired product was cooled to obtain a lump of calcium metaphosphate. The obtained lump of calcium metaphosphate was pulverized by use of a porcelain mortar, and washing and filtration with deionized water were repeated until the filtrate becomes neutral. The obtained precipitate was dried in a dryer set to 120° C. to thereby obtain calcium metaphosphate powder.

(Performance Evaluation)

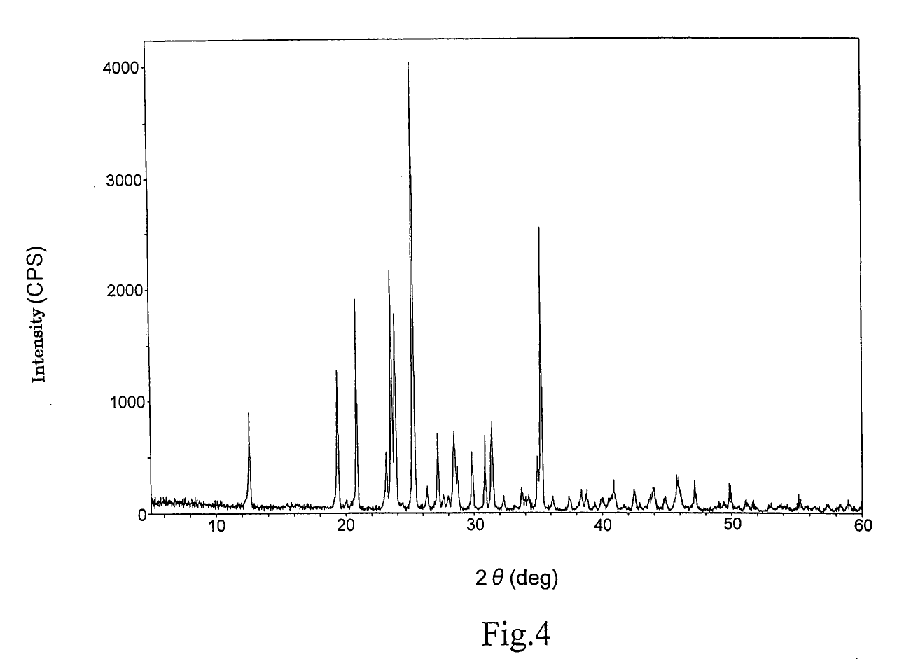

The calcium metaphosphate obtained in the Example was measured for the content of coloring metal elements by means of the above-described method. Also, the purity of the calcium metaphosphate (the content of P₂O₅ and CaO) was determined by the method described in Purity measurement (5) below. Further, the molar ratio (P₂O₅/CaO), in the calcium metaphosphate was determined. Further, the content of free phosphoric acid in the calcium metaphosphate and the ignition loss were determined by means of the above-described method. The results are shown in Table 5 below. Moreover, the crystal structure of the calcium metaphosphate powder obtained in Example 5-1 was determined by means of an X-ray diffractometer. The results are shown in FIG. 4. The measurement conditions were: a Cu Kα radiation source, a scan speed of 4°/min, and a scan range 2θ=5 to 60°.

(Purity Measurement (5))

In the measurement of the purity of the calcium metaphosphate, the content of P₂O₅ and the content CaO were determined separately, and these were summed to evaluate the purity of the calcium metaphosphate. The procedure for the determination is as follows. 1.0 g of the obtained calcium metaphosphate powder was weighed into a Teflon (registered trademark) vessel. 10 ml of 20% NaOH solution was added thereto, and then decomposition was performed by use of a microwave digester (product of MILESTONE, MLS1200 MEGA). Further, 10 ml of concentrated hydrochloric acid was added thereto to process again by use of the microwave digester. The obtained solution was transferred to a 100-ml volumetric flask, and deionized water was added up to the mark. This solution (hereinafter referred to as A) was employed for determining each of the purities. The contents of CaO and P₂O₅ were determined by means of the following methods.

(1) Content of CaO

a. Taking 10 ml of solution A in a conical beaker, and adding 20 ml of an M/20 EDTA standard solution thereto.

b. Adding 2 ml of a 1M ammonium chloride buffer solution, adding deionized water to 150 ml, and adding aqueous ammonia to a pH of about 10.

c. Adding 2 drops of an eriochrome black T indicator. This solution serves as a test solution.

d. Titrating with an M/20 calcium standard solution, and defining the end point as the point at which the color changes from blue to red.

e. Performing a blank test through employing the same procedure as in the operations a to d except that solution A is not added in a. The content of calcium oxide is determined by the following equation:

$$CaO ( \% ) = ( B - A ) ⨯ \frac{1}{20} ⨯ f ⨯ 56.0778$$

wherein A represents the titer (ml) in the test solution, B represents the titer (ml) in the blank test, f represents the factor of the calcium standard solution, and 56.0778 represents the atomic weight of calcium oxide.
(2) Content of P₂O₅

a. Taking 10 ml of solution A in a 100-ml volumetric flask, and adding pure water to adjust the volume.

b. Taking 10 ml of the prepared solution in a to a 100-ml volumetric flask, and adding pure water to about 30 ml.

c. Adding 4 ml of nitric acid, heating to boil on a heater, and then heating for 5 minutes.

d. After water cooling, adding a drop of phenolphthalein thereto, adjusting the pH to slightly acidic by use of aqueous ammonia and dilute nitric acid, and then adding pure water to about 70 ml.

e. Adding 20 ml of ammonium vanadomolybdate while stirring the solution obtained in d.

f. Adding pure water up to the mark to adjust the volume, and allowing to stand for 30 minutes. This solution serves as a test solution.

g. Measuring the absorbancy of the test solution by means of the following method under the measurement conditions of λ=430 nm, cell=20 mm glass cell, and measurement time=60 sec: performing cell correction with a diphosphorus pentaoxide first standard solution as a control solution; and subsequently determining the absorbancy of the test solution and a diphosphorus pentaoxide second standard solution. The content of diphosphorus pentaoxide is determined by use of the following equation:

$${P}_{2} {O}_{5} ( \% ) = ( \frac{0.2}{A} ⨯ B + C ) ⨯ 100 ⨯ 22.9136 / S$$

wherein A represents the absorbancy of the diphosphorus pentaoxide second standard solution, B represents the absorbancy of the test solution, C represents the weight of P contained in the diphosphorus pentaoxide first standard solution, and S represents the weight of the sample.

The diphosphorus pentaoxide standard solutions are prepared in accordance with the following method: taking 15 and 16 ml of a 0.458 mg/ml diphosphorus pentaoxide solution in respective 100-ml volumetric flasks; adding 50 ml of pure water; adding 20 ml of a coloring reagent while stirring; adding pure water up to the mark to adjust the volume; and allowing to stand for 30 minutes. The obtained solutions serve as the diphosphorus pentaoxide first standard solution (containing 0.0687 mg/ml of diphosphorus pentaoxide) and the diphosphorus pentaoxide second standard solution (containing 0.0733 mg/ml of diphosphorus pentaoxide), respectively.

(Molar Ratio (P₂O₅/CaO))

The evaluation is performed by use of the following equation:

$$Molar ratio ( {P}_{2} {O}_{5} / CaO ) = \frac{{P}_{2} {O}_{5} content ( \% )}{CaO content ( \% )} ⨯ 0.395$$

TABLE 5

| | Example 5-1 |
|---|---|
| P₂O₅ content (wt. %) | 72.62 |
| CaO content (wt. %) | 26.26 |
| Purity (wt. %) | 98.88 |
| Molar ratio (P₂O₅/CaO) | 1.09 |
| Free phosphoric acid (wt. %) | 0.00 |
| Ignition loss (wt. %) | 0.10 |
| Iron (ppm) | 2.1 |
| Chromium (ppm) | 0.1 |
| Manganese (ppm) | 0.1 |
| Nickel (ppm) | 0.1 |
| Copper (ppm) | 1.6 |

### Example 6-1

(1) First Step

230.7 g of phosphoric acid (product of Nippon Chemical Industrial Co., Ltd., concentration of H₃PO₄:85%, pure phosphoric acid) was charged into a 500-ml beaker, and 140.3 g of a magnesium hydroxide slurry was added thereto at a rate of 5 ml/min while water cooling. The magnesium hydroxide slurry employed was prepared by dispersing 40.3 g of magnesium oxide into 100 g of deionized water. The molar ratio of magnesium hydroxide to phosphoric acid (the former: the latter) was 1:2. After the addition of the entire volume of the magnesium hydroxide slurry, the reaction vessel was heated to 140° C. to allow the reaction to proceed for 30 minutes, thereby obtaining a clear viscous paste-like substance.

(2) Second Step

The paste-like substance obtained in the first step was transferred to and filled in an alumina firing vessel on which magnesium metaphosphate powder was spread in advance. The firing vessel was placed in an electric furnace and heated from room temperature to 550° C. at a rate of 5° C./min. This temperature was maintained for 3 hours for firing. Upon completion of the firing, the fired product was cooled to obtain a lump of magnesium metaphosphate. The obtained lump of magnesium metaphosphate was pulverized by use of a porcelain mortar, to thereby obtain magnesium metaphosphate powder.

(Performance Evaluation)

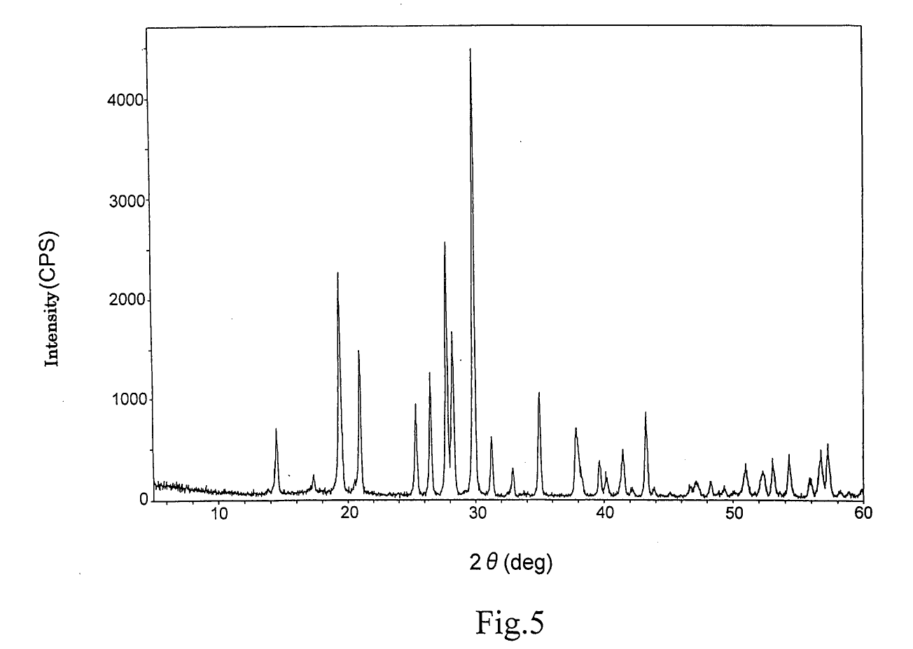

The magnesium metaphosphate obtained in the Example was measured for the content of coloring metal elements by means of the above-described method. Also, the purity of the magnesium metaphosphate (the content of P₂O₅ and MgO) was determined by the method described in Purity measurement (6) below. Further, the molar ratio (P₂O₅/MgO) in the magnesium metaphosphate was determined. Further, the content of free phosphoric acid in the magnesium metaphosphate and the ignition loss were determined by means of the above-described method. The results are shown in Table 6 below. Moreover, the crystal structure of the magnesium metaphosphate powder obtained in Example 6-1 was determined by means of an X-ray diffractometer. The results are shown in FIG. 5. The measurement conditions were: a Cu Kα radiation source, a scan speed of 4°/min, and a scan range 2θ=5 to 60°.

(Purity Measurement (6))

In the measurement of the purity of the magnesium metaphosphate, the content of P₂O₅ and the content of MgO were determined separately, and these were summed to evaluate the purity of the magnesium metaphosphate. The procedure for the determination is as follows. 1.0 g of the obtained magnesium metaphosphate powder was weighed into a Teflon (registered trademark) vessel. 10 ml of 20% NaOH solution was added thereto, and then decomposition was performed by use of a microwave digester (product of MILESTONE, MLS1200 MEGA). Further, 10 ml of concentrated hydrochloric acid was added to process again by use of the microwave digester. The obtained solution was transferred to a 100-ml volumetric flask, and deionized water was added up to the mark. This solution (hereinafter referred to as A) was employed for determining each of the purities. The contents of MgO and P₂O₅ were determined by means of the following methods.

(1) Content of MgO

a. Taking 10 ml of solution A in a conical beaker, and adding 20 ml of an M/20 EDTA standard solution thereto.

b. Adding 2 ml of a 1M ammonium chloride buffer solution, adding deionized water to 150 ml, and adding aqueous ammonia to a pH of about 10.

c. Adding 2 drops of an eriochrome black T indicator. This solution serves as a test solution.

d. Titrating with an M/20 magnesium standard solution, and defining the end point as the point at which the color changes from blue to red.

e. Performing a blank test through employing the same procedure as in the operations a to d except that solution A is not added in a. The content of magnesium oxide is determined by the following equation:

$$MgO ( \% ) = ( B - A ) ⨯ \frac{1}{20} ⨯ f ⨯ 40.3045$$

wherein A represents the titer (ml) in the test solution, B represents the titer (ml) in the blank test, f represents the factor of the magnesium standard solution, and 40.3045 represents the molecular weight of magnesium oxide.

(2) Content of P₂O₅

a. Taking 10 ml of solution A in a 100-ml volumetric flask, and adding pure water to adjust the volume.

b. Taking 10 ml of the solution prepared in a in a 100-ml volumetric flask, and adding pure water to about 30 ml.

c. Adding 4 ml of nitric acid, heating to boil on a heater, and then heating for 5 minutes.

d. After water cooling, adding a drop of phenolphthalein thereto, adjusting the pH to slightly acidic by use of aqueous ammonia and dilute nitric acid, and then adding pure water to about 70 ml.

e. Adding 20 ml of ammonium vanadomolybdate while stirring the solution obtained in d.

f. Adding pure water up to the mark to adjust the volume, and allowing to stand for 30 minutes. This solution serves as a test solution.

g. Measuring the absorbancy of the test solution by means of the following method under the measurement conditions of λ=430 nm, cell=20 mm glass cell, and measurement time=60 sec: performing cell correction with a diphosphorus pentaoxide first standard solution as a control solution, and subsequently determining the absorbancy of the test solution and a diphosphorus pentaoxide second standard solution. The content of diphosphorus pentaoxide is determined by use of the following equation:

$${P}_{2} {O}_{5} ( \% ) = ( \frac{0.2}{A} ⨯ B + C ) ⨯ 100 ⨯ 22.9136 / S$$

wherein A represents the absorbancy of the second phosphorous standard solution, B represents the absorbancy of the test solution, C represents the weight of P contained in the first phosphorous standard solution, and S represents the weight of the sample.

The diphosphorus pentaoxide standard solutions are prepared in accordance with the following method: taking 16 and 17 ml of a 0.458 mg/ml diphosphorus pentaoxide solution in respective 100-ml volumetric flasks; adding 50 ml of pure water; adding 20 ml of a coloring reagent while stirring; adding pure water up to the mark to adjust the volume; and allowing to stand for 30 minutes. The obtained solutions serve as the diphosphorus pentaoxide first standard solution (containing 0.0733 mg/ml of diphosphorus pentaoxide) and the diphosphorus pentaoxide second standard solution (containing 0.0779 mg/ml of diphosphorus pentaoxide), respectively.

(Molar Ratio (P₂O₅/MgO))

The evaluation is performed by use of the following equation:

$$Molar ratio ( {P}_{2} {O}_{5} / Mg O ) = \frac{{P}_{2} {O}_{5} content ( \% )}{MgO content ( \% )} ⨯ 0.284$$

TABLE 6

| | Example 6-1 |
|---|---|
| P₂O₅ content (wt. %) | 78.67 |
| MgO content (wt. %) | 21.62 |
| Purity (wt. %) | 100.29 |
| Molar ratio (P₂O₅/BaO) | 1.03 |
| Free phosphoric acid (wt. %) | 0.00 |
| Ignition loss (wt. %) | 0.40 |
| Iron (ppm) | 0.6 |
| Chromium (ppm) | 0.1 |
| Manganese (ppm) | 0.3 |
| Nickel (ppm) | 0.1 |
| Copper (ppm) | 0.7 |

As has been described above, the high purity metaphosphate of the present invention has a low content of impurities consisting of various coloring metal elements. Therefore, the high purity metaphosphate of the present invention is particularly suitably employed as a raw material for producing an optical lens for a digital video, a digital camera, and the like, a raw material for producing a high transparency glass for short wavelength laser in a digital video disc player, a raw material for producing a fiber for amplification, and a raw material for a secondary battery electrolyte.

1. A high purity metaphosphate characterized in that the concentration of each coloring metal element serving as an impurity is 5 ppm or less.

2. The high-purity metaphosphate according to claim 1, wherein said coloring metal is at least one of iron, chromium, nickel, manganese, and copper.

3. The high-purity metaphosphate according to claim 1, wherein the content of free phosphoric acid is 2 wt. % or less.

4. The high-purity metaphosphate according to claim 1, wherein ignition loss is 2 wt. % or less.

5. The high-purity metaphosphate according to claim 1, wherein the high-purity metaphosphate is an aluminum salt.

6. The high-purity metaphosphate according to claim 1, wherein the high-purity metaphosphate is a barium salt.

7. The high-purity metaphosphate according to claim 1, wherein the high-purity metaphosphate is a zinc salt.

8. The high-purity metaphosphate according to claim 1, wherein the high-purity metaphosphate is a calcium salt.

9. The high-purity metaphosphate according to claim 1, wherein the high-purity metaphosphate is a magnesium salt.

10. The high-purity metaphosphate according to claim 1 employed as a raw material for producing an optical lens or a raw material for a glass for laser beam amplification.

11. A method for producing a high purity metaphosphate comprising the steps of:
producing a phosphate of a metal by reacting phosphoric acid with a compound of the metal which composes a metaphosphate; and
placing the phosphate obtained in the previous step on a powder of a metaphosphate which is spread in a firing vessel prior to placing the phosphate, followed by subjecting the phosphate to firing.

12. The method for producing a high-purity metaphosphate according to claim 11, wherein a vessel made of metal aluminum, alumina, or cordierite is employed as the firing vessel in the second step.

13. The method for producing a high-purity metaphosphate according to claim 11 further comprising a third step of pulverizing the firing product obtained in the second step.

14. The method for producing a high-purity metaphosphate according to claim 13 further comprising a fourth step of removing free phosphoric acid by washing and then drying the pulverized product obtained in the third step.

15. A method for producing the high-purity metaphosphate according to claim 5 characterized in that placing a mixture obtained by mixing an aluminum compound, anhydrous phosphoric acid, and ployphosphoric acid on aluminum metaphosphate powder which is spread in a firing vessel prior to placing the mixture and, subjecting the mixture to firing.

16. The method for producing a high-purity metaphosphate according to claim 15, wherein a vessel made of metal aluminum or alumina is employed as the firing vessel.

17. The method for producing a high-purity metaphosphate according to claim 15, wherein free phosphoric acid is removed by washing and then drying the firing product.
